(19) United States
(12) Patent Application Publication
(10) Pub. No.: US 2026/0248104 A1
(43) Pub. Date: Aug. 27, 2026

(54) METHOD OF INDIVIDUAL IDENTIFICATION OF ANIMAL AND NON-TRANSITORY COMPUTER-READABLE STORAGE MEDIUM STORING COMPUTER PROGRAM

(71) Applicant: SEIKO EPSON CORPORATION, TOKYO (JP)

(72) Inventors: Naoki HAGIHARA, SHIOJIRI-SHI (JP); Hikaru KURASAWA, Matsumoto-shi (JP); Ryoki WATANABE, Matsumoto-shi (JP)

(21) Appl. No.: 19/550,433

(22) Filed: Feb. 26, 2026

(30) Foreign Application Priority Data
Feb. 26, 2025 (JP) 2025-028473

(51) Int. Cl. A01K 11/00; G06V 10/74; G06V 40/10

(52) U.S. Cl. CPC A01K 11/006; G06V 10/761; G06V 40/10

(57) ABSTRACT

A method of disclosure includes: (a) acquiring a target image related to a backside of the identification target animal; (b) obtaining an embedding vector from the target image using a deep metric learning model; (c) calculating a distance between a registered embedding vector generated in advance related to each of a plurality of registered individuals and the embedding vector using registration data including the registered embedding vector; (d) determining whether the identification target animal is any of the plurality of registered individuals or an unregistered individual that is not registered in the registration data using the distance; (e) registering data related to the identification target animal as temporary registration data when the identification target animal is the unregistered individual; and (f) making a transition of the temporary registration data to the registration data when the temporary registration data satisfies a transition condition set in advance.

### CROSS-REFERENCE TO RELATED APPLICATION

The present application is based on, and claims priority from JP Application Serial Number 2025-028473, filed Feb. 26, 2025, the disclosure of which is hereby incorporated by reference herein in its entirety.

### BACKGROUND

### 1. Technical Field

The present disclosure relates to a method of individual identification of an animal and a non-transitory computer-readable storage medium storing a computer program.

### 2. Related Art

JP-A-2022-48464 discloses a technique for collating cow muzzle pattern images. In this related art, the muzzle pattern images are collated by extracting the muzzle pattern image from a face image of a cow, obtaining a feature vector of the muzzle pattern image using a neural network for classifying the muzzle pattern image, and calculating the similarity between that feature vector and a known feature vector.

JP-A-2022-48464 is an example of the related art.

However, in the related art, a face image having such high-resolution that a fine structure of the muzzle pattern can be discriminated is required, and there is a problem that it is difficult to acquire such a face image. For example, it is difficult to stop a movement of a cow that is continuously walking in order to take an image of that cow. Such a problem is not limited to individual identification of cows but is common to individual identification of other animals such as pigs. Therefore, there is a demand for a technique capable of performing individual identification using other features than the muzzle pattern.

### SUMMARY

According to a first aspect of the present disclosure, a method of performing individual identification of an identification target animal is provided. This method includes: (a) acquiring a target image related to a backside of the identification target animal; (b) obtaining an embedding vector from the target image using a deep metric learning model; (c) calculating a distance between a registered embedding vector generated in advance related to each of a plurality of registered individuals and the embedding vector using registration data including the registered embedding vector; (d) determining whether the identification target animal is any of the plurality of registered individuals or an unregistered individual that is not registered in the registration data using the distance; (e) registering data related to the identification target animal as temporary registration data when the identification target animal is the unregistered individual; and (f) making a transition of the temporary registration data to the registration data when the temporary registration data satisfies a transition condition set in advance.

According to a second aspect of the present disclosure, there is provided a non-transitory computer-readable storage medium storing a computer program configured to make a processor execute processing of individual identification of an identification target animal. This computer program makes the processor execute the processing including: (a) acquiring a target image related to a backside of the identification target animal; (b) obtaining an embedding vector from the target image by using a deep metric learning model; (c) calculating a distance between a registered embedding vector generated in advance for each of a plurality of registered individuals and the embedding vector by using registration data including the registered embedding vector; (d) determining whether the identification target animal is any of the plurality of registered individuals or an unregistered individual that is not registered in the registration data using the distance; (e) registering data related to the identification target animal as temporary registration data when the identification target animal is the unregistered individual; and (f) making a transition of the temporary registration data to the registration data when the temporary registration data satisfies a transition condition set in advance.

### BRIEF DESCRIPTION OF THE DRAWINGS

FIG. 1 is a block diagram showing a configuration of an individual identification system according to a first embodiment.

FIG. 2 is a flowchart showing a procedure of learning of a deep metric learning model and generation of registration data.

FIG. 3 is a flowchart showing a detailed procedure of step S20.

FIG. 4 is a diagram illustrating the contents of generation processing of target images in step S20.

FIG. 5 is a diagram illustrating an example of the registration data.

FIG. 6 is a flowchart showing a procedure of individual identification processing in a first embodiment.

FIG. 7 is a diagram illustrating an example of embedding vectors calculated in the individual identification processing.

FIG. 8 is a diagram illustrating an example of distances between the embedding vectors and registered embedding vectors.

FIG. 9 is a flowchart showing a detailed procedure in step S170 in the first embodiment.

FIG. 10 is a diagram illustrating an example of temporary registration data.

FIG. 11 is a diagram illustrating an example of distances between the embedding vectors and temporarily registered embedding vectors.

FIG. 12 is a flowchart showing a procedure of update processing of the registration data.

FIG. 13 is a flowchart showing a procedure of deletion processing of a temporarily registered individual.

FIG. 14 is a block diagram showing a configuration of an individual identification system according to a second embodiment.

FIG. 15 is a diagram illustrating an example of the registration data in the second embodiment.

FIG. 16 is a flowchart showing a procedure of individual identification processing in the second embodiment.

FIG. 17 is a diagram illustrating an example of embedding vectors in the second embodiment.

FIG. 18 is a diagram illustrating an example of distances between the embedding vectors and registered embedding vectors in the second embodiment.

FIG. 19 is a diagram illustrating an example of various determination distances in the second embodiment.

FIG. 20 is a flowchart showing a detailed procedure in step S150a in the second embodiment.

FIG. 21 is a flowchart showing a detailed procedure of step S150a in a third embodiment.

FIG. 22 is a flowchart showing a detailed procedure of step S150a in a fourth embodiment.

### DESCRIPTION OF EMBODIMENTS

### A. First Embodiment

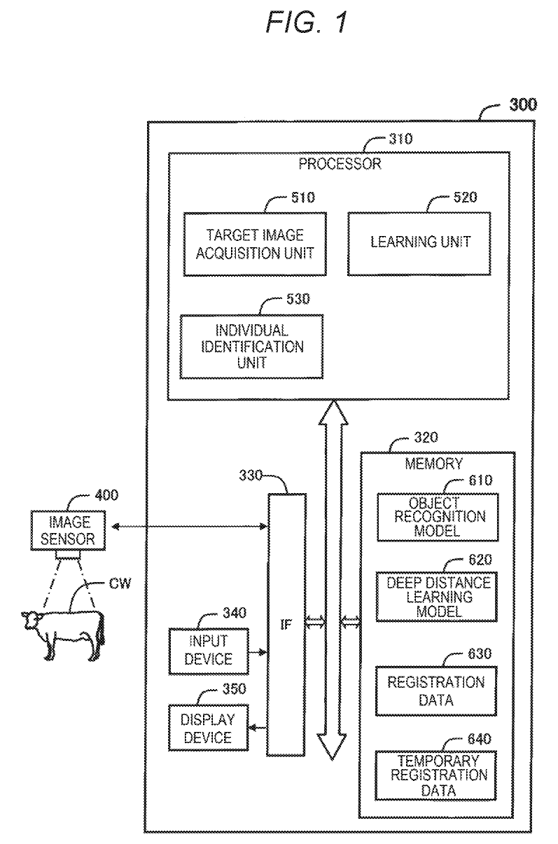

FIG. 1 is a diagram illustrating a configuration of an individual identification system according to a first embodiment. This individual identification system includes an information processing apparatus 300 and an image sensor 400. In the present embodiment, a processing target of individual identification is a cow CW. However, other animals such as pigs, dogs, and cats may be used as the processing target instead of cows.

The image sensor 400 is a camera that captures an image of the cow CW that is a target of individual identification processing. The image sensor 400 is preferably installed so as to capture an image of a backside of the cow CW from above the cow CW. As the image sensor 400, a video camera that captures a moving image may be used, or a still image camera that captures a still image may be used. Further, as the image sensor 400, various sensors exemplified below can be used.

### (1) Depth Sensor

By using a depth image captured by a depth sensor, the individual identification can be performed based on unevenness of a backside of a cow.

### (2) RGB Sensor (Color Image Sensor)

By using a color image captured by an RGB sensor, the individual identification can be performed based on a monochrome pattern which is a mottled pattern on a backside of a cow. When there is dirt on the backside of a cow, the color image changes, and therefore, there is a possibility that erroneous recognition occurs when the individual identification is performed using only the RGB sensor. Meanwhile, the depth image captured by the depth sensor is not affected by dirt on a backside of a cow, and therefore has an advantage that the possibility of the erroneous recognition due to the dirt is low.

### (3) Spectral Sensor

By using a spectral image captured by a spectroscopic sensor, the individual identification can be performed based on monochrome patterns which are mottled patterns of respective wavelengths of a backside of a cow.

### (4) Thermosensor

By using a thermo-image captured by a thermosensor, the individual identification can be performed based on an intensity distribution of an infrared ray on a backside of a cow. The intensity distribution of the infrared ray on a backside of a cow is an image reflecting that the degree of scattering of the infrared ray changes depending on the length of the hair and that the distance changes due to the unevenness and the degree of diffusion of the infrared ray changes.

The information processing apparatus 300 executes the individual identification of the cow CW using an image that is related to the backside of the cow CW and is captured by the image sensor 400. The information processing apparatus 300 includes a processor 310, a memory 320, an interface circuit 330, and an input device 340 and a display device 350 coupled to the interface circuit 330. The image sensor 400 is also coupled to the interface circuit 330. The processor 310 has not only a function of executing processing described in detail below, but also a function of displaying data obtained by that processing and data generated in the process of that processing on the display device 350. The information processing apparatus 300 can be realized by a computer such as a personal computer.

The processor 310 has functions of a target image acquisition unit 510, a learning unit 520, and an individual identification unit 530. The target image acquisition unit 510 acquires a plurality of target images from a backside image captured by the image sensor 400. The learning unit 520 executes distance learning of a deep metric learning model 620. The individual identification unit 530 executes individual identification of the cow CW using the deep metric learning model 620 having been learned. The functions of these units are realized by the processor 310 executing a computer program stored in the memory 320. However, some of these functions may be implemented by a hardware circuit. The processor in the present disclosure is a term including such a hardware circuit. Further, one or more processors that execute the various types of processing may be processors provided to one or more remote computers coupled via a network.

The similarity may be used as the distance learned by the deep metric learning model 620. The high similarity corresponds to a small distance. That is, "small distance" is equivalent to "high similarity". In the following description, "distance" is used as a term including "similarity".

The memory 320 stores an object recognition model 610, the deep metric learning model 620, registration data 630, and temporary registration data 640. The object recognition model 610 is a machine learning model that takes an image of the cow CW as an input and a plurality of key points that are geometric feature points of the cow CW as an output. In the present embodiment, it is assumed that the object recognition model 610 has been learned. The object recognition model 610 can also be referred to as a "feature recognition model".

The deep metric learning model 620 is a machine learning model that takes the image of the cow CW as an input and an embedding vector as an output. The embedding vector is also referred to as a "feature vector". The deep metric learning model 620 can be configured using, for example, FaceNet.

The registration data 630 is a database in which an individual ID and a plurality of embedding vectors obtained using the deep metric learning model 620 are registered for each of the plurality of registered individuals. The individual ID is, for example, an individual identification number displayed on an earmark of the cow CW. The embedding vector registered in the registration data 630 is referred to as a "registered embedding vector". An image of each registered individual may be registered in the registration data 630 in addition to the registered embedding vector.

The temporary registration data 640 is data in which an unregistered individual that is not registered in the registration data 630 is temporarily registered when the unregistered individual is detected in the individual identification processing described later. The content of the temporary registration data 640 will be described later.

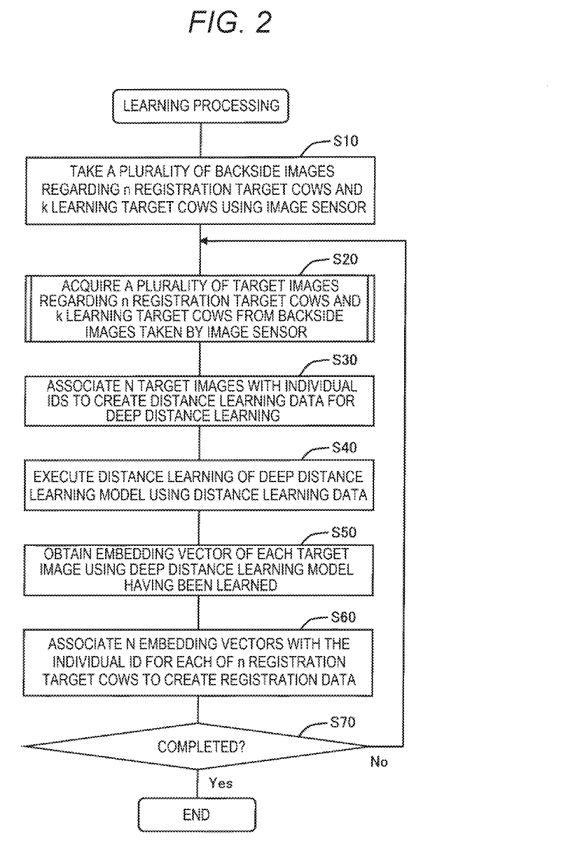

FIG. 2 is a flowchart showing a procedure of learning of the deep metric learning model 620 and generation of the registration data 630. In the following description, it is assumed that n is an integer no smaller than 2 and n registration target cows are registered in the registration data 630. In the present embodiment, the n registration target cows are the same in breed.

In step S10, the target image acquisition unit 510 captures a plurality of backside images related to the backside for each of the n registration target cows and k learning target cows using the image sensors 400. Here, n and k are each an integer no smaller than 2. This image capturing can be performed when, for example, each cow sequentially passes below the image sensors 400. When a moving image is captured, a plurality of frame images is selected as the backside images from the moving image. This selection can be performed by, for example, automatically selecting the frame image including the backside portion of the registration target cow using an annotation tool. Alternatively, an operator may manually perform the selection.

In step S20, the target image acquisition unit 510 acquires a plurality of target images related to the backside for each of the n registration target cows and the k learning target cows from the backside images captured by the image sensor 400. The "learning target cow" means a cow to be used to generate learning data of the deep metric learning model 620. In the deep distance learning, it is desirable to perform learning of the neural network using learning data different from the registration data 630 from the viewpoint of robustness. Further, it is desirable to generate the learning data so as to include more data than the registration data 630. Therefore, k is preferably set to a number greater than n. However, the learning target cows may include the registration target cow as a part thereof. Further, by setting n=k, the same cow may be used as both the learning target cow and the registration target cow. The number of target images acquired from each cow may be set to a constant value N, or may be set to a number different by individual cow. Here, N is an integer no smaller than 1, but is preferably set to be no smaller than 2.

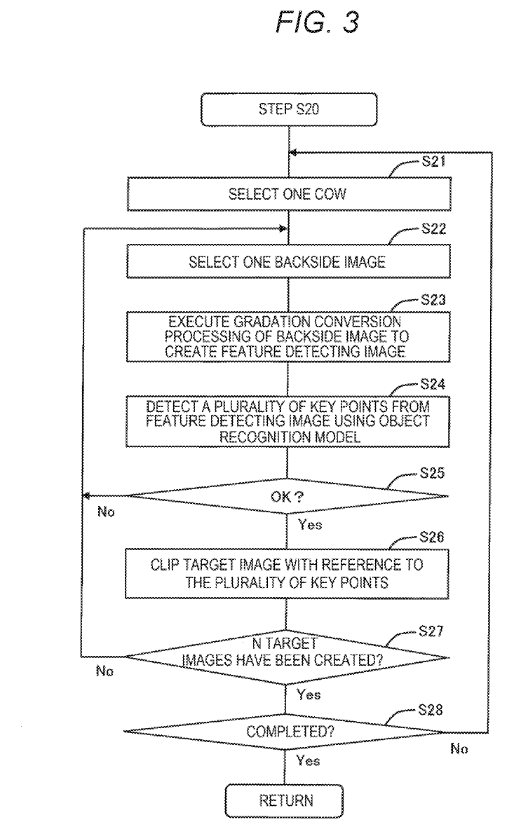

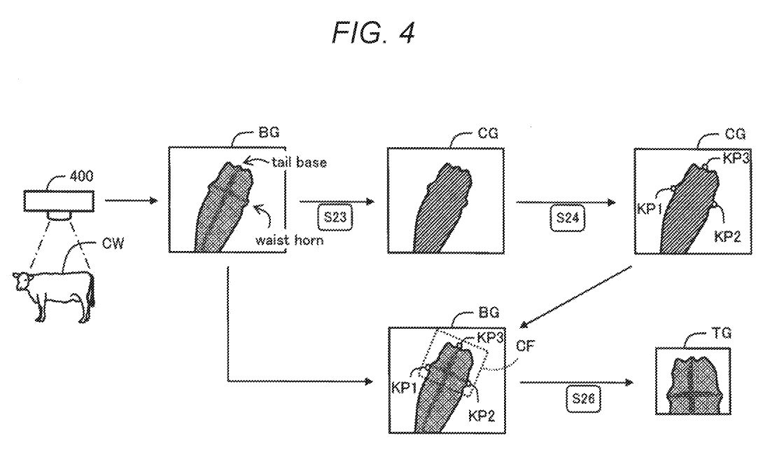

FIG. 3 is a flowchart showing a detailed procedure of step S20, and FIG. 4 is a diagram illustrating the processing contents thereof. In the first embodiment, a depth sensor is used as the image sensor 400. In FIG. 4, some of step numbers are added.

The backside image BG shown in FIG. 4 includes a rear portion of the cow CW including a waist angle and the base of the tail. Since the individual cow CW is characterized by a shape of the rear portion of the cow CW, the backside image BG preferably includes the rear portion of the cow CW including the waist angle and the base of the tail.

In step S21, the target image acquisition unit 510 selects one cow as a processing target from the n registration target cows and the k learning target cows. In step S22, the target image acquisition unit 510 selects one backside image BG as a processing target from the plurality of backside images BG. In step S23, the target image acquisition unit 510 generates a feature detecting image CG by executing gradation conversion processing of the backside image BG. The gradation conversion processing is processing of extracting a gradation range in which a contour of the cow is easily detected out of all gradations of the backside image BG and converting the backside image BG into an image having a predetermined number of gradations. For example, when the backside image BG, which is a depth image, is an image having 2400 gradations, the feature detecting image CG may be generated by extracting 512 intermediate gradations from the backside image BG and compressing the gradations to 256 gradations. However, step S23 may be omitted.

In step S24, the target image acquisition unit 510 detects a plurality of key points from the feature detecting image CG using the object recognition model 610. In the example of FIG. 4, two key points KP1, KP2 are detected at the position of the waist angle of the cow CW, and one key point KP3 is detected at the position of the base of the tail. These key points KP1 to KP3 are feature points present on an outline of the cow CW. The object recognition model 610 is a machine learning model that takes the feature detecting image CG as an input and the plurality of key points KP1 to KP3 as an output. However, the object recognition model 610 may be configured to recognize a key point representing another position. The object recognition model 610 can be configured using, for example, DeepLabCut or ResNet, which is a deep learning model. The object recognition model 610 may be configured using another machine learning model.

In step S25, the target image acquisition unit 510 determines whether a predetermined number of key points KP1 to KP3 are detected. When the predetermined number of key points KP1 to KP3 are not detected, the process returns to step S22, a new backside image BG is selected as a processing target, and the processing in step S23 and subsequent steps is executed once again. When the predetermined number of key points KP1 to KP3 are detected, the process proceeds to step S26.

In step S26, the target image acquisition unit 510 clips the target image TG from the backside image BG with reference to the plurality of key points KP1 to KP3. The target image TG is an image including a characterizing portion of the backside of the cow. In the example in FIG. 4, in the backside image BG, a state in which the clipping frame CF with reference to the key points KP1 to KP3 is set, and the target image TG clipped in accordance with the clipping frame CF are drawn. On this occasion, it is preferable to execute a rotation or a size change of the target image TG so that a direction or a size of the waist angle of the cow CW in the target image TG becomes a desired value. Further, pixel values of the target image TG may be normalized. This normalization is processing of, for example, normalizing the pixel value as a minimum depth value as 1.0, and the pixel value as a maximum depth value as 0, and further, converting the pixel values in a range of 0 to 1.0 into the gradations of 0 to 255. Note that steps S23 to S26 may be omitted to thereby use the backside image BG directly as the target image TG.

In step S27, the target image acquisition unit 510 determines whether N target images TG have been generated for one cow. When the N target images TG have not been generated, the process returns to step S22, a new backside image BG is selected as the processing target, and the processing in step S22 and subsequent steps is executed once again. When the N target images TG have been generated, the process proceeds to step S28.

In step S28, the target image acquisition unit 510 determines whether the processing has been completed for all the n registration target cows and the k learning target cows. When the processing has not been completed for all the cows, the process returns to step S21, a new cow is selected as the processing target, and the processing in step S22 and subsequent steps is executed once again. When the processing for all the cows is completed, the processing in step S20 ends.

In step S30 in FIG. 2, the learning unit 520 generates distance learning data for the deep distance learning by associating N target images TG acquired for each learning target cow with the individual ID. The individual ID is usually input by the user. When the user determines the individual ID of the cow, since it is easier to identify the cow with the color image than to identify the cow with the depth image, it is preferable to display the color image of the cow captured using the RGB sensor on the display device 350. As described above, the individual identification number displayed on the earmark of the cow CW is used as the individual ID.

In step S40, the learning unit 520 executes the distance learning of the deep metric learning model 620 using the distance learning data. This distance learning is processing of adjusting internal parameters of the deep metric learning model 620 such that the distance is short in the same individual and the distance is long in different individuals with respect to the embedding vectors output from the deep metric learning model 620. As the distance of the embedding vectors, for example, a Euclidean distance between the vectors may be used, or an angle between the vectors may be used.

In step S50, the learning unit 520 sequentially inputs N target images TG related to each registration target cow to the deep metric learning model 620 that has been learned, and obtains the embedding vector for each of the target images TG. As a result, N embedding vectors are obtained for each registration target cow. In step S60, the learning unit 520 generates the registration data 630 by associating N embedding vectors with the individual ID for each of the n registration target cows.

In step S70, the learning unit 520 determines whether the processing has been completed for all the backside images captured in step S10. When the processing is completed, the processing in FIG. 2 ends. When the processing is not completed, the process returns to step S20, and the processing in steps S20 to S70 is executed once again for the next backside image.

By performing the learning processing in FIG. 2 described above, the deep metric learning model 620 having been learned and the registration data 630 related to the n registration target cows are obtained. In the following description, the registration target cow is referred to as a "registered individual". Further, the embedding vector registered in the registration data 630 is referred to as a "registered embedding vector".

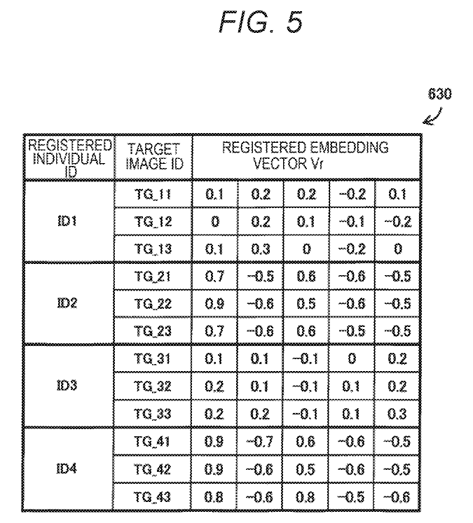

FIG. 5 is a diagram illustrating an example of the registration data 630. In this example, the number n of registration target cows is 4, and the number N of target images TG is 3. In the registration data 630, the registered embedding vectors Vr related to three target images TG are registered for each of the four registered individuals. In this example, the registered embedding vectors Vr are each a five-dimensional vector having five elements. The individual IDs of the four registered individuals are ID1 to ID4. Further, image IDs different from each other are assigned to the three target images TG obtained for each individual. However, the image IDs are not required to be registered. Normally, a larger number of registered embedding vectors Vr are registered for each registered individual, but in FIG. 5, the number of registered embedding vectors Vr is reduced for the sake of convenience of illustration.

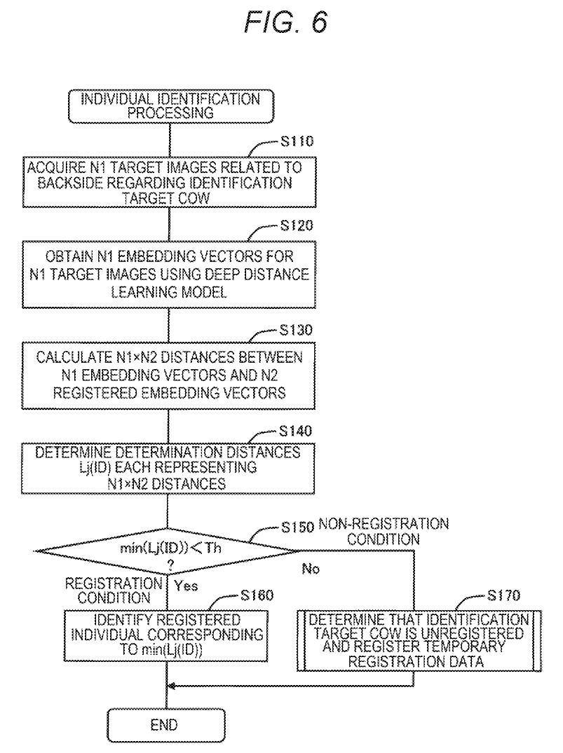

FIG. 6 is a flowchart showing a procedure of the individual identification processing in the first embodiment. It is preferable that the individual identification processing is periodically performed on, for example, all cows reared in the same farm as identification target cows.

In step S110, the individual identification unit 530 acquires N1 target images TG related to the backside using the image sensor 400 regarding one identification target cow. Here, N1 is an integer equal to or greater than 1. The value of N1 may be set to a value equal to the number of registered embedding vectors related to each of the registered individuals registered in the registration data 630, or may be set to a value different therefrom. In addition, N1 may be set to the number of target images TG that are acquired at that time regarding the identification target cow instead of a value set in advance. In the following description, the number of registered embedding vectors related to each registered individual is referred to as "N2" to be distinguished from the number N1 of target images TG of the identification target cow. The integer N2 is the same as the integer N used in FIGS. 2 and 3, and is an integer no smaller than 2. In the example in FIG. 5, the number N2 of the registered embedding vectors is 3. The specific processing contents of step S110 are the same as the generation processing of the target image TG for the registration target cow described in FIGS. 3 and 4.

In step S120, the individual identification unit 530 obtains N1 embedding vectors for the N1 target images TG using the deep metric learning model 620 having been learned.

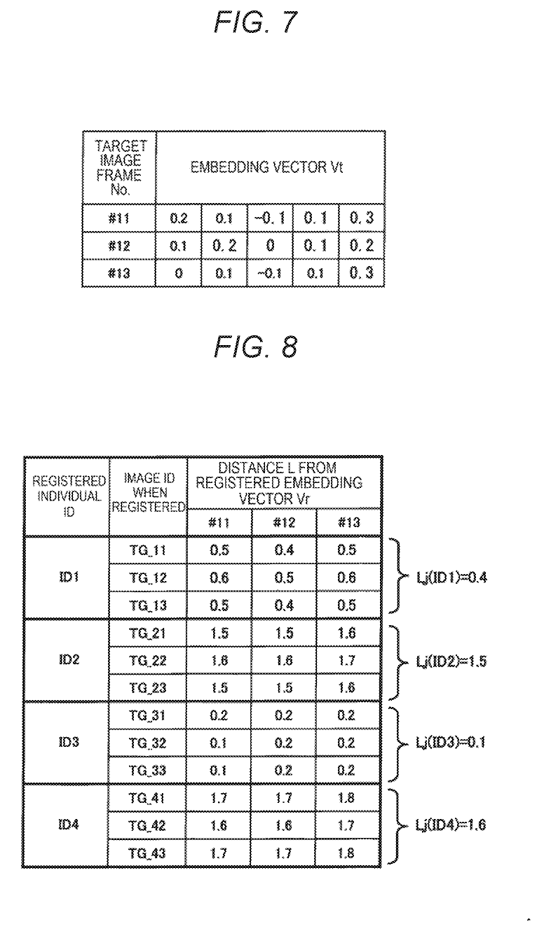

FIG. 7 is a diagram illustrating an example of an embedding vector calculated in the individual identification processing. In this example, the number N1 of target images TG is 3. That is, the embedding vectors Vt are calculated respectively for the three target images TG obtained with respect to the identification target cow. The embedding vector Vt is a vector the same in dimension as the registered embedding vector Vr illustrated in FIG. 5.

In step S130, the individual identification unit 530 calculates the distances between the N1 embedding vectors and the N2 registered embedding vectors related to each of the registered individuals. As a result, N1×N2 distances are calculated for each registered individual. Since there are n registered individuals, n×N1×N2 distances are calculated for one identification target cow.

FIG. 8 is a diagram illustrating an example of the distances between the embedding vectors and the registered embedding vectors. Since n=4, N2=3 are true in the registered embedding vectors Vr shown in FIG. 5, and N1=3 is true in the embedding vectors Vt shown in FIG. 7, 36 distances L are calculated for one identification target cow.

In step S140, the individual identification unit 530 determines a determination distance Lj(ID) representing N1×N2 distances for each of the n registered individuals. The reference symbol "ID" in the determination distance Lj(ID) means the individual ID of the registered individual. The determination distance Lj(ID) is determined by, for example, any of the following methods.

### Method JM1 of Determining Determination Distance Lj(ID)

For each registered individual, M distances L are selected from the smallest out of the N1×N2 distances L, and a value proportional to an average value of the M distances L is determined as a determination distance Lj(ID). Here, M is an integer no smaller than 2 and no larger than N1×N2, and is preferably an integer smaller than N1×N2. In addition, it is preferable that the integers N1, N2 are set so that N1×N2 is no smaller than 3. In the present disclosure, a value proportional to a specific value means a value obtained by multiplying the specific value by a positive coefficient, and may be the specific value itself.

### Method JM2 of Determining Determination Distance Lj(ID)

For each registered individual, a value proportional to the minimum value of the N1×N2 distances L is determined as the determination distance Lj(ID).

In the first embodiment, the determination distance Lj(ID) is determined in accordance with the determination method JM1. In FIG. 8 described above, the determination distance Lj(ID) calculated using M=3 is described for each registered individual.

In step S150 in FIG. 6, the individual identification unit 530 uses the determination distances Lj(ID) to determine whether the registration condition is satisfied or the non-registration condition is satisfied. The "registration condition" is a condition indicating that the identification target cow corresponds to any of the plurality of registered individuals registered in the registration data 630. The "non-registration condition" is a condition indicating that the identification target cow is not registered in the registration data 630. Specifically, in step S150, when the minimum value of the determination distances Lj(ID) is smaller than a determination threshold value Th set in advance, it is considered that the registration condition is satisfied, and the process proceeds to step S160. In step S160, the individual identification unit 530 identifies the registered individual corresponding to the minimum value of the determination distances Lj(ID) as the individual of the identification target cow. In the example of FIG. 8, since the minimum value of the determination distances Lj(ID) is the determination distance Lj(ID) corresponding to the registered individual having the individual ID of ID3, this registered individual is identified as the individual of the identification target cow.

On the other hand, when the minimum value of the determination distances Lj(ID) is larger than the determination threshold value Th, it is considered that the non-registration condition is satisfied, and the process proceeds to step S170. The minimum value of the determination distances Lj(ID) becomes larger than the determination threshold value Th when the identification target cow is an unregistered individual, or when there is dirt on the backside of the identification target cow. In this case, in step S170, the individual identification unit 530 determines that the identification target cow is unregistered, and registers the temporary registration data 640. "Unregistered" means that the identification target cow is not registered in the registration data 630.

Note that when the minimum value of the determination distances Lj(ID) is equal to the determination threshold value Th, the process proceeds to a branch destination selected in advance out of the two branch destinations from step S150. The same applies to other determination steps using threshold values.

In step S150, it may be determined which one of the registered individuals the identification target cow corresponds to or whether the identification target cow is an unregistered individual using other conditions different from those described above. That is, when the N1×N2 distances satisfy the non-registration condition set in advance, it can be determined that the identification target cow is an unregistered individual. Examples of other non-registration conditions will be described in second and subsequent embodiments.

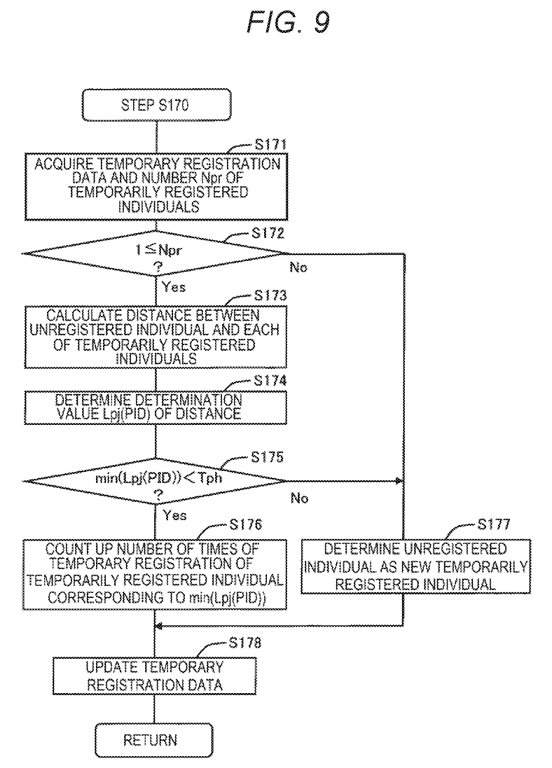

FIG. 9 is a flowchart showing a detailed procedure in step S170 in the first embodiment. In step S171, the individual identification unit 530 acquires the content of the temporary registration data 640 and the number Npr of temporarily registered individuals registered in the temporary registration data 640.

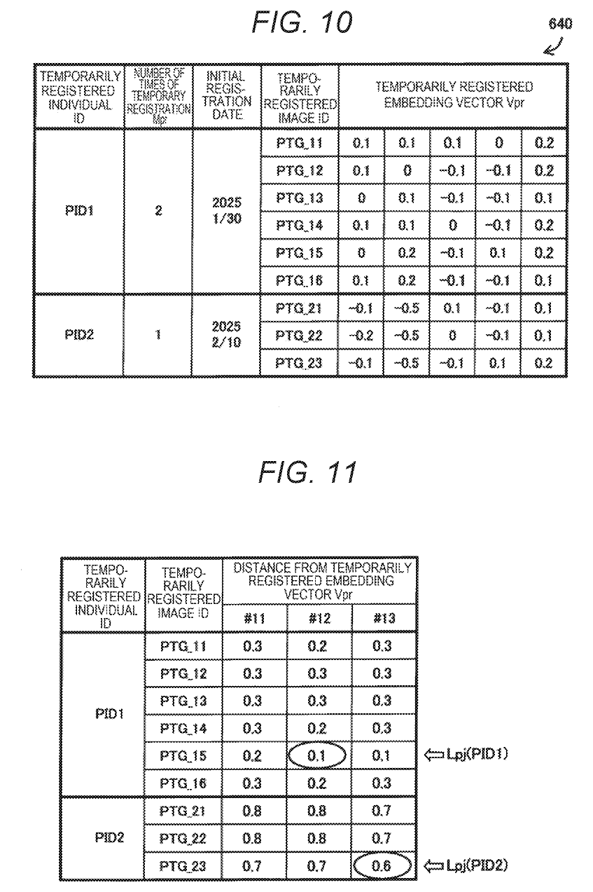

FIG. 10 is a diagram illustrating an example of the temporary registration data 640. In this example, the number Npr of temporarily registered individuals is 2. In the temporary registration data 640, a temporarily registered individual ID, the number of times Mpr of temporary registration, an initial registration date, a temporarily registered image ID, and a temporarily registered embedding vector Vpr obtained from the temporarily registered image are registered for each of the temporarily registered individuals. However, the temporarily registered image ID can be omitted. Further, the target image used for creating the temporarily registered embedding vector Vpr may be registered in the temporary registration data 640. The temporarily registered individual ID is irrelevant to the earmark of the temporarily registered individual, and is, for example, a consecutive number automatically determined when the temporarily registered individual is registered in the temporary registration data 640.

In the example in FIG. 10, three temporarily registered embedding vectors Vpr related to three temporarily registered images are registered in every temporary registration. For example, since the number of times Mpr of temporary registration of the temporarily registered individual having the temporarily registered individual ID of PID1 is 2, six temporarily registered embedding vectors Vpr are registered. Further, since the number of times Mpr of temporary registration of the temporarily registered individual having the temporarily registered individual ID of PID2 is 1, three temporarily registered embedding vectors Vpr are registered.

In step S172, the individual identification unit 530 determines whether the number Npr of temporarily registered individuals registered in the temporary registration data 640 is one or more. When the number Npr of temporarily registered individuals is less than 1, that is, when no temporarily registered individual is registered in the temporary registration data 640, the process proceeds to step S177, and the individual identification unit 530 determines that the unregistered individual is a new temporarily registered individual. After step S177, the process proceeds to step S178 described later.

On the other hand, when the number Npr of temporarily registered individuals registered in the temporary registration data 640 is 1 or more, the process proceeds to step S173, and the individual identification unit 530 calculates a distance between the unregistered individual and each of the temporarily registered individuals. Defining the number of embedding vectors Vt of the unregistered individual as N1 and the number of temporarily registered embedding vectors Vpr of each of the temporarily registered individuals as N3, N1×N3 distances are calculated.

FIG. 11 is a diagram illustrating an example of the distances between the embedding vectors and the temporarily registered embedding vectors. In this example, it is assumed when it is determined that the identification target cow is the unregistered individual in the individual identification processing using the embedding vectors Vt illustrated in FIG. 7, and the distances between the embedding vectors Vt in FIG. 7 and the temporarily registered embedding vectors Vpr in FIG. 10 are calculated. For the first temporarily registered individual, since the number N3 of temporarily registered embedding vectors Vpr is 6, N1×N3=18 distances are calculated. Further, for the second temporarily registered individual, since the number N3 of temporarily registered embedding vectors Vpr is 3, N1×N3=9 distances are calculated.

In step S174, the individual identification unit 530 determines a determination value Lpj(PID) representing the N1×N3 distances obtained in step S174 for each of the temporarily registered individuals. The reference symbol "PID" in the determination value Lpj(PID) means the temporarily registered individual ID. The determination value Lpj(PID) is determined by a method substantially the same as, for example, any of the determination methods JM1, JM2 of the determination distance Lj(ID) described above. In the example in FIG. 11, M distances L from the smallest value are selected out of the N1×N2 distances L in accordance with the determination method JM1, and a value proportional to an average value of the M distances L is determined as the determination value Lpj(PID).

In step S175, the individual identification unit 530 determines whether the minimum value of the determination values Lpj(PID) is smaller than a threshold value Tph set in advance. When the minimum value of the determination values Lpj(PID) is larger than the threshold value Tph, the process proceeds to step S177 described above, and the individual identification unit 530 determines that the unregistered individual is a new temporarily registered individual.

On the other hand, when the minimum value of the determination values Lpj(PID) is smaller than the threshold value Tph, the process proceeds to step S176, and the number of times Mpr of temporary registration of the temporarily registered individual corresponding to the minimum value of the determination values Lpj(PID) is counted up by one. In the example of FIG. 11, it is assumed that the minimum value of the determination values Lpj(PID) is 0.1, which is smaller than the threshold value Tph. In this case, the number of times Mpr of temporary registration of the temporarily registered individual having the temporarily registered individual ID of PID1 is counted up by one.

In step S178, the individual identification unit 530 updates the temporary registration data 640. That is, for the temporarily registered individual the number of times Mpr of temporary registration of which has been counted up in step S176, the temporarily registered embedding vectors Vpr are additionally registered in the temporary registration data 640. Further, when it is determined in step S177 that the temporarily registered individual is a new temporarily registered individual, the temporarily registered individual ID, the number of times Mpr (=1) of temporary registration, the initial registration date, and the temporarily registered embedding vectors Vpr of the temporarily registered individual are registered in the temporary registration data 640.

According to the processing in FIG. 6 described above, the individual of the identification target cow can be determined from the N1×N2 distances related to each of the registered individuals. Further, when the N1×N2 distances satisfy the non-registration condition set in advance, it can be determined that the identification target cow is an unregistered individual. Further, when it is determined that the identification target cow is the unregistered individual, data related to the unregistered individual can be registered in the temporary registration data 640 by the processing in FIG. 9.

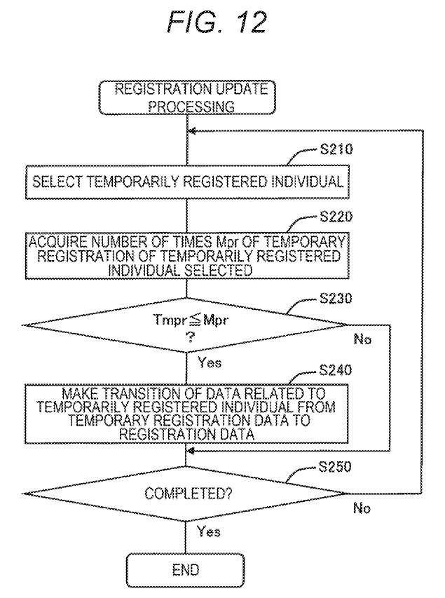

FIG. 12 is a flowchart showing a procedure of update processing of the registration data. This processing is preferably executed periodically.

In step S210, the individual identification unit 530 selects one temporarily registered individual registered in the temporary registration data 640. In step S220, the individual identification unit 530 acquires the number of times Mpr of temporary registration of the temporarily registered individual thus selected. In step S230, the individual identification unit 530 determines whether the number of times Mpr of temporary registration is equal to or greater than a threshold value Tmpr of the number of times. The threshold value Tmpr of the number of times is an integer no smaller than 2, and is preferably set to 3 or more.

When the number of times Mpr of temporary registration is equal to or greater than the threshold value Tmpr of the number of times, it is considered that a transition condition set in advance is satisfied, and the process proceeds to step S240, and the individual identification unit 530 makes the transition of the data related to the temporarily registered individual from the temporary registration data 640 to the registration data 630. That is, the data related to the temporarily registered individual is deleted from the temporary registration data 640 and is registered in the registration data 630. When making the transition from the temporary registration data 640 to the registration data 630, the user preferably inputs and registers the registered individual ID. The registered individual ID is the individual identification number displayed on the earmark of the cow. However, the operation of inputting the individual identification number in the earmark to the registration data 630 as the registered individual ID may be executed at any timing on and after step S240. As described above, when the registered individual ID is input, it is preferable to display the color image of the cow captured using the RGB sensor on the display device 350.

Note that as the transition condition for making the transition of the temporarily registered individual from the temporary registration data 640 to the registration data 630, other conditions than that "the number of times Mpr of temporary registration is equal to or greater than the threshold value Tmpr of the number of times" may be used. For example, a transition condition that "the number of temporarily registered embedding vectors Vpr is equal to or greater than a threshold value of the number of pieces" may be used.

When the number of times Mpr of temporary registration is smaller than the threshold value Tmpr of the number of times in step S230, the process proceeds to step S250 skipping step S240. In step S250, the individual identification unit 530 determines whether the processing in steps S210 to S240 has been completed for all the temporarily registered individuals registered in the temporary registration data 640. When the processing has not been completed, the process returns to step S210, and the processing in steps S210 to S250 is executed once again.

Note that in steps S220 and S230, it may be determined whether to make the transition of the data of the temporarily registered individual to the registration data 630 using a different condition from the condition described above. For example, it is possible to determine that the transition of the data of one temporarily registered individual to the registration data 630 is made when the number of temporarily registered embedding vectors Vpr related to that temporarily registered individual is equal to or greater than a threshold value of the number of pieces set in advance. As can be understood from these examples, when the temporary registration data 640 satisfies a registration condition set in advance, the temporarily registered individual can be registered as the registered individual.

According to the registration update processing in FIG. 12, since the transition of the data related to the temporarily registered individual from the temporary registration data 640 to the registration data 630 is made when the number of times Mpr of temporary registration is equal to or greater than the threshold value Tmpr of the number of times, an appropriate registered individual can be registered in the registration data 630. In addition, it is not necessary to register the earmarks as registered individual IDs for all unregistered individuals, and it is sufficient to register the earmarks as the registered individual IDs when the number of times MPr of temporary registration is equal to or greater than the threshold value Tmpr of the number of times, and therefore, the number of times of registration of the earmarks can be reduced.

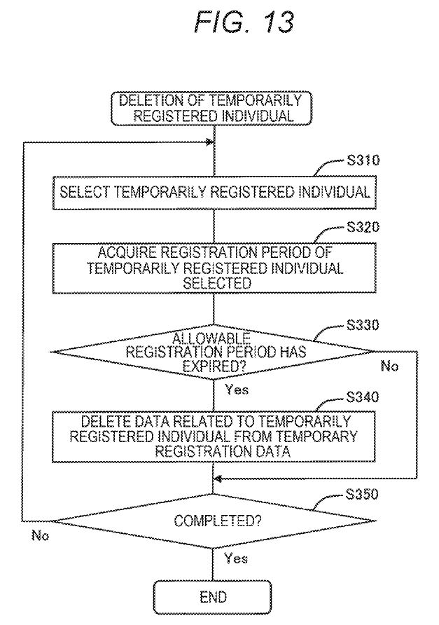

FIG. 13 is a flowchart showing a procedure of deletion processing of the temporarily registered individual. This processing is preferably executed periodically.

In step S310, the individual identification unit 530 selects one temporarily registered individual registered in the temporary registration data 640. In step S320, the individual identification unit 530 acquires the registration period of the temporarily registered individual thus selected. The "registration period" is an elapsed period from a timing at which the temporarily registered individual is first registered in the temporary registration data 640 to a timing at which the processing in FIG. 13 is executed. In the present embodiment, the registration period is the number of elapsed days from the initial registration date illustrated in FIG. 10.

In step S330, the individual identification unit 530 determines whether the registration period exceeds an allowable registration period set in advance. The allowable registration period is a period in which the data related to the temporarily registered individual is allowed to be registered in the temporary registration data 640. The reason for setting the allowable registration period is that there is a possibility that the number of temporarily registered individuals registered over a long period increases to make the data amount of the temporary registration data 640 excessive unless such a period is set.

In step S330, when the registration period of the temporarily registered individual exceeds the allowable registration period, the process proceeds to step S340, and the individual identification unit 530 deletes the data related to the temporarily registered individual from the temporary registration data 640. In the processing in FIG. 12 described above, since the transition of the data related to the temporarily registered individual from the temporary registration data 640 to the registration data 630 is made when the number of times Mpr of temporary registration is equal to or greater than the threshold value Tmpr of the number of times, it is assumed that the number of times Mpr of temporary registration has not reached the threshold value Tmpr of the number of times for the temporarily registered individuals subjected to the processing in step S330. Therefore, the processing in steps S330, S340 corresponds to processing of deleting the data related to the temporarily registered individual from the temporary registration data 640 when the registration period of that temporarily registered individual exceeds the allowable registration period before the number of times Mpr of temporary registration reaches the threshold value Tmpr of the number of times.

In step S330, when the registration period of the temporarily registered individual does not exceed the allowable registration period, the process proceeds to step S350 skipping step S340. In step S350, the individual identification unit 530 determines whether the processing in steps S310 to S340 has been completed for all the temporarily registered individuals registered in the temporary registration data 640. When the processing is not completed, the process returns to step S310, and the processing in steps S310 to S350 is executed once again for the next temporarily registered individual.

According to the deletion processing in FIG. 13, when the registration period of the temporarily registered individual exceeds the allowable registration period before the number of times of temporary registration reaches the threshold value of the number of times, the data related to that temporarily registered individual is deleted from the temporary registration data 640, and therefore, an unnecessary temporarily registered individual can be deleted from the temporary registration data 640. Note that other conditions may be used as the deletion condition. For example, the count-up date when the number of times Mpr of temporary registration of the temporarily registered individual is counted up in the processing in FIG. 9 may be stored, and the data related to that temporarily registered individual may be deleted when the period from the count-up date exceeds the allowable period.

According to the first embodiment described above, the embedding vector Vt can be obtained from the target image related to the backside of the identification target animal using the deep metric learning model 620, and the individual can be identified using the distance between the embedding vector Vt and the registered embedding vector Vr. Further, when the identification target animal is an unregistered individual, the identification target animal can be registered as a temporarily registered individual in the temporary registration data 640, and when the temporary registration data 640 satisfies the registration condition set in advance, the temporarily registered individual can be registered as a registered individual in the registration data 630.

### B. Second Embodiment

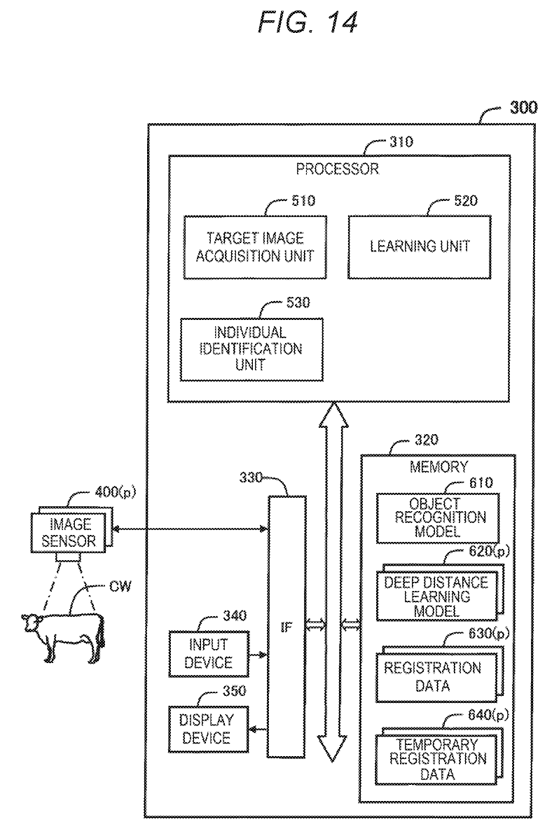

FIG. 14 is a diagram illustrating a configuration of an individual identification system according to a second embodiment. The individual identification system of the second embodiment is different from that of the first embodiment in that a plurality of image sensors 400(p), a plurality of deep metric learning models 620(p), a plurality of registration data 630(p), and a plurality of temporary registration data 640(p) are provided, and is the same as that of the first embodiment in the rest of the configuration. The character p at the end of these reference numerals is an ordinal number from 1 to P, and P is an integer no smaller than 2.

As the plurality of image sensors 400(p), a combination of various different image sensors described in the first embodiment or a combination of the same type of image sensors can be used. When a combination of the image sensors of the same type is used, it is preferable to set the plurality of image sensors different in at least one attribute such as an installation angle or a field angle from each other. In the plurality of image sensors 400(p), it is preferable that relative positions of respective sensor coordinate systems are known and a coordinate transformation matrix related to any two sensor coordinate systems is known.

The number P of the image sensors 400(p) is an integer no smaller than 2. In the second embodiment, P=2 is set, and a moving image of the backside of the cow CW is captured using two image sensors 400, that is, the depth sensor and the RGB sensor. It is preferable that the depth sensor and the RGB sensor have substantially the same imaging region and are configured to be able to capture images at the same imaging timing. For example, one RGBD sensor including the depth sensor and the RGB sensor can be used as the image sensor 400(p).

In the following description, a reference symbol attached with (p) at the foot thereof means that the reference symbol corresponds to the ordinal number p of the deep metric learning model 620(p). Further, a prefix of "p-th type" also means that the prefix corresponds to the ordinal number p of the deep metric learning model 620. For example, the p-th type embedding vector registered in the p-th registration data 630(p) is referred to as a "p-th type registered embedding vector".

Since the learning processing described in FIGS. 2 to 4 in the first embodiment is similarly applied to each deep metric learning model 620(p), the description thereof will be omitted.

Note that in the processing in FIG. 3 related to the image captured by the RGB sensor, similarly to the processing related to the image captured by the depth sensor, it is possible to detect the plurality of key points KP1 to KP3 from the backside image BG captured by the RGB sensor and set the clipping frame CF with reference to these key points. Alternatively, it is possible to convert the coordinates of the plurality of key points KP1 to KP3 detected from the backside image BG by the depth sensor into coordinates of the sensor coordinate system of the RGB sensor using a coordinate conversion matrix between the depth sensor and the RGB sensor, and set the clipping frame CF based on the key points KP1 to KP3 after the coordinate conversion. The latter method is particularly useful when the depth sensor and the RGB sensor are configured as a single RGBD sensor.

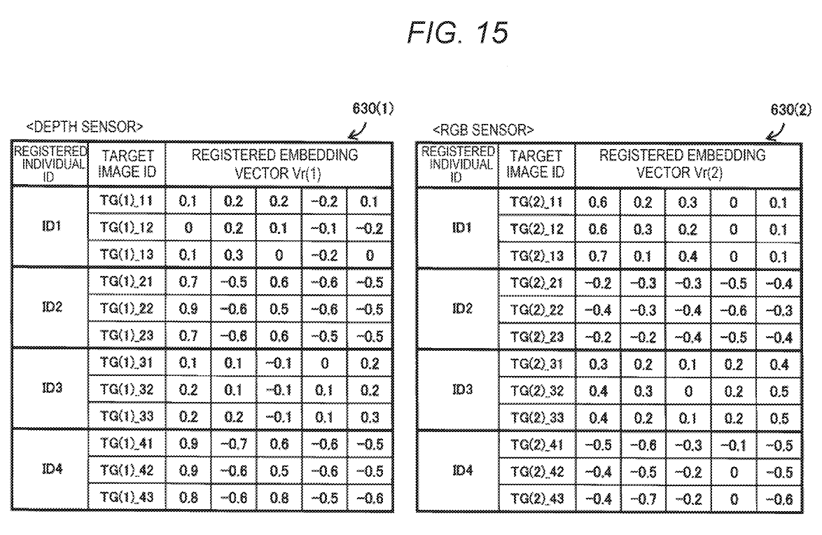

FIG. 15 is a diagram illustrating an example of the registration data 630(p) in the second embodiment. In this example, two image sensors, that is, the depth sensor and the RGB sensor are used as the P image sensors 400(p). Further, the number n of registration target cows is 4, and the number N(p) of target images TG is N(1)=N(2)=3. The registration data 630(p) includes first registration data 630(1) generated using the depth sensor and second registration data 630(2) generated using the RGB sensor. The first registration data 630(1) is the same as the registration data 630 of the first embodiment shown in FIG. 5. In the second registration data 630(2), registered embedding vectors Vr(2) related to three target images TG are registered for each of the four individuals that are the same as in the first registration data 630(1).

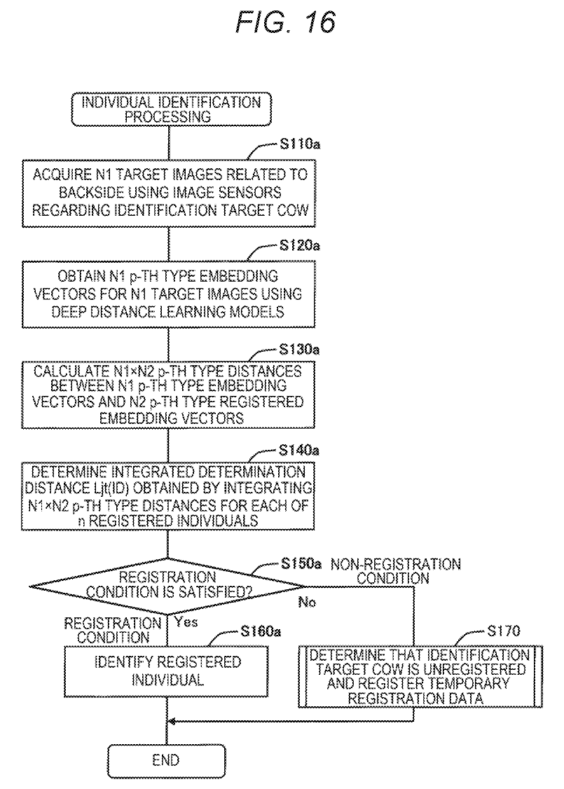

FIG. 16 is a flowchart showing a procedure of individual identification processing in the second embodiment. Steps S110a to S160a are obtained by changing steps S110 to S160 of the individual identification processing in the first embodiment shown in FIG. 6, and the processing in step S170 is substantially the same as that in the first embodiment.

In step S110a, the individual identification unit 530 acquires N1 target images TG related to the backside using each of the two image sensors 500(p) regarding one identification target cow. Here, N1 is an integer equal to or greater than 1. Similarly to the first embodiment, the number of p-th type registered embedding vectors related to each registered individual is referred to as "N2" to be distinguished from the number N1 of target images TG of the identification target cow. The integer N2 is an integer no smaller than 2. Note that each of the integers N1 and N2 is preferably a constant value that does not depend on the ordinal number p.

In step S120a, the individual identification unit 530 obtains N1p-th type embedding vectors regarding N1 target images TG using each of the P deep metric learning models 620(p) having been learned.

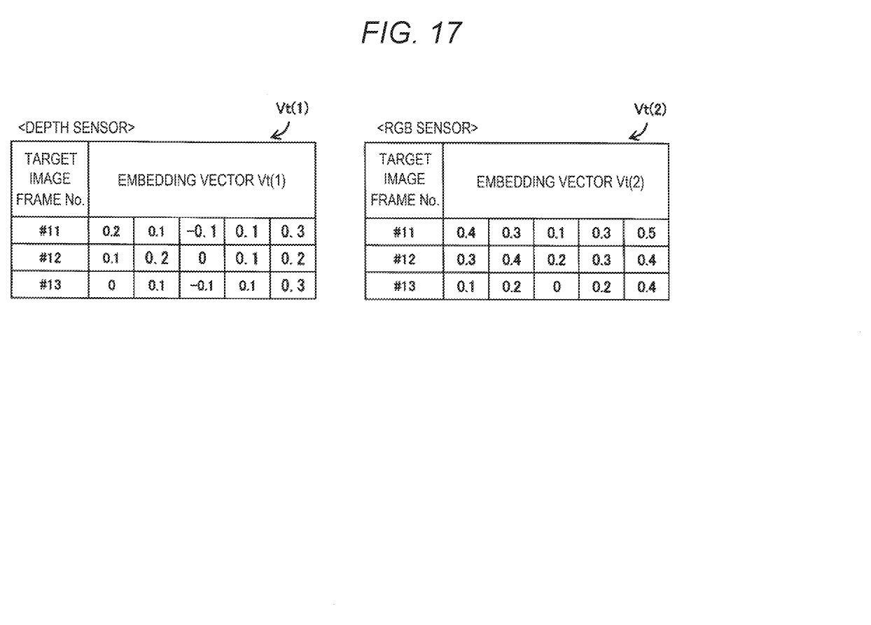

FIG. 17 is a diagram illustrating an example of the embedding vectors in the second embodiment. The first type embedding vector Vt(1) is calculated using an image captured using the depth sensor, and is the same as the embedding vector Vt illustrated in FIG. 7. The second type embedding vector Vt(2) is calculated using an image captured using the RGB sensor.

In step S130a, the individual identification unit 530 calculates a distance between the N1p-th type embedding vectors and the N2p-th type registered embedding vectors related to each of the registered individuals. As a result, N1×N2p-th type distances are calculated for each registered individual. In addition, since there are n registered individuals, n×N1×N2p-th type distances are calculated from the image captured by each of the image sensors 400(p) with respect to one identification target cow.

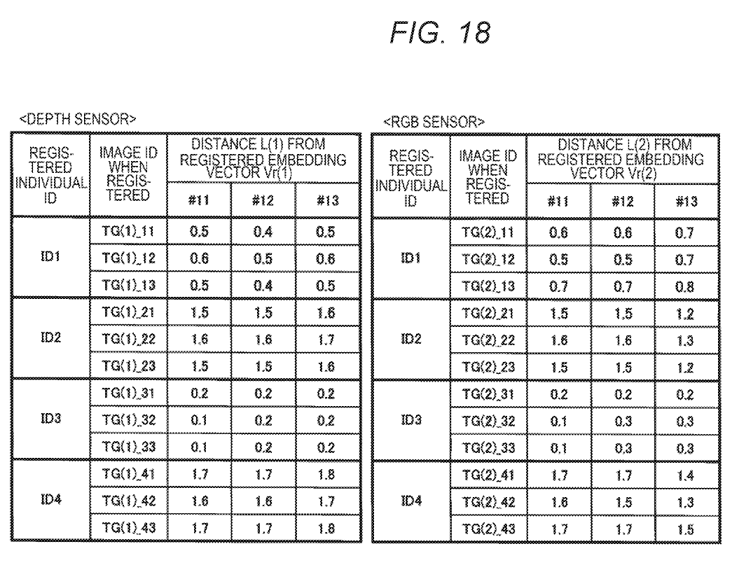

FIG. 18 is a diagram illustrating an example of the distances between the embedding vectors and the registered embedding vectors in the second embodiment. Since n=4, N2=3 are true in the registered embedding vectors Vr(p) shown in FIG. 15, and N1=3 is true in the embedding vectors Vt(p) shown in FIG. 17, 36p-th type distances L(p) are calculated from the images captured by each of the image sensors 400(p) for one identification target cow.

In step S140a, the individual identification unit 530 determines an integrated determination distance Ljt(ID) obtained by integrating N1×N2p-th type distances for each of the n registered individuals. The integrated determination distance Ljt(ID) can be determined by, for example, any of the following methods.

### Method DM1 of Determining Integrated Determination Distance Ljt(ID)

For each of the registered individuals, a value proportional to an addition result obtained by adding a first type distance average value obtained by averaging M first type distances L(1) selected from the smallest value out of the N1×N2 first type distances L(1) and a second type distance average value obtained by averaging M second type distances L(2) selected from the smallest value out of the N1×N2 second type distances L(2) is determined as the integrated determination distance Ljt(ID). The value M is an integer no smaller than 2and no larger than N1×N2, and is preferably an integer smaller than N1×N2. In addition, it is preferable that the integers N1, N2 are set so that N1×N2 is no smaller than 3.

### Method DM2 of Determining Integrated Determination Distance Ljt(ID)

For each of the registered individuals, M addition results are selected from the smallest value out of the N1×N2 addition results obtained by adding N1×N2 first type distances L(1) and the N1×N2 second type distances L(2) corresponding thereto, and a value proportional to an average value of the M addition results thus selected is determined as the integrated determination distance Ljt(ID). The term "corresponding" means a result obtained using the images captured at substantially the same capturing timing using the two image sensors 400(p). Specifically, the first type distance L(1) and the second type distance L(2) obtained respectively using the images of the same frame number captured by the depth sensor and the RGB sensor correspond to the distances "corresponding" to each other.

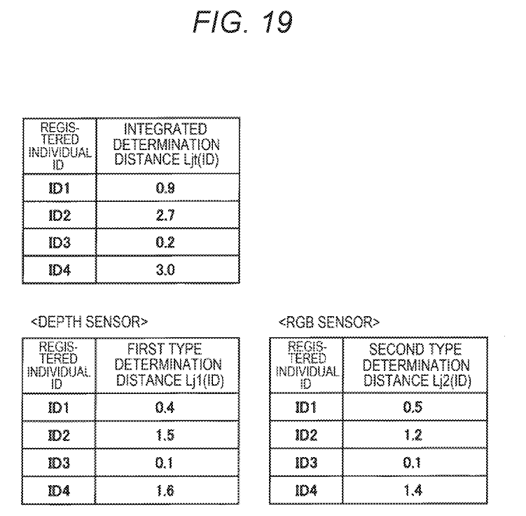

FIG. 19 is a diagram illustrating an example of various determination distances in the second embodiment. An upper part of FIG. 19 illustrates an integrated determination distance Ljt(ID) calculated using M=3 and applying the determination method DM1 described above to the p-th type distances illustrated in FIG. 18.

In step S150a, the individual identification unit 530 uses the integrated determination distances Ljt(ID) to determine whether the registration condition is satisfied or the non-registration condition is satisfied. When the registration condition is satisfied, the process proceeds to step S160a, and it is identified whether the identification target cow corresponds to any one of the plurality of registered individuals. On the other hand, when the non-registration condition is satisfied, the process proceeds to step S170, and the identification target cow is determined to be unregistered and is then registered in the temporary registration data 640(p).

The processing in step S170 in the second embodiment can be executed in accordance with the detailed procedure in FIG. 9 of the first embodiment. On this occasion, as the "distance" used in steps S174, S175, at least one of an integrated distance obtained by combining the first type distance L(1) and the second type distance L(2), the first type distance L(1), and the second type distance L(2) can be used. That is, for example, any of the following can be used as the determination processing in step S175.

### First Determination Processing JP1

When the integrated determination value determined using the first type distance L(1) and the second type distance L(2) is smaller than an integrated threshold value, Yes is determined, and when the integrated determination value is larger than the integrated threshold value, No is determined. The integrated determination value can be determined in accordance with a method similar to any of the determination methods DM1 and DM2 described above.

### Second Determination Processing JP2

When two or more of the integrated determination value determined using the first type distance L(1) and the second type distance L(2), the first type determination value determined using the first type distance L(1), and the second type determination value determined using the second type distance L(2) are smaller than the respective threshold values, Yes is determined, and otherwise, No is determined.

### Third Determination Processing JP3

When all of the integrated determination value determined using the first type distance L(1) and the second type distance L(2), the first type determination value determined using the first type distance L(1), and the second type determination value determined using the second type distance L(2) are smaller than the respective threshold values, Yes is determined, and otherwise, No is determined.

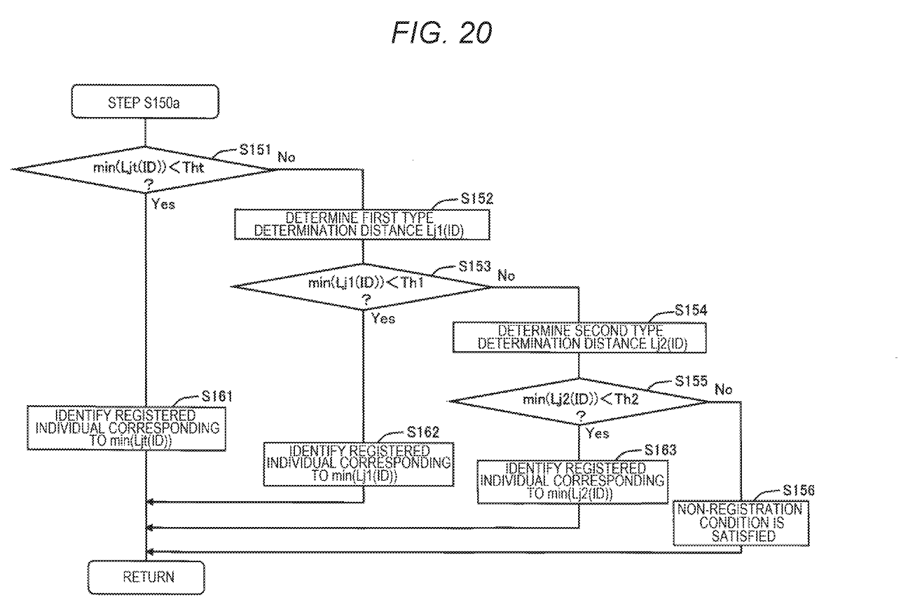

FIG. 20 is a flowchart showing a detailed procedure in step S150a in the second embodiment. In step S151, the individual identification unit 530 determines whether the minimum value of the integrated determination distances Ljt(ID) is smaller than the integrated threshold value Tht set in advance. When the minimum value of the integrated determination distances Ljt(ID) is smaller than the integrated threshold value Tht, the process proceeds to step S161, and the registered individual corresponding to the minimum value of the integrated determination distances Ljt(ID) is identified as the individual of the identification target cow. In the example in FIG. 19, since the minimum value of the integrated determination distances Ljt(ID) corresponds to the registered individual having the individual ID of ID3, this registered individual is identified as the individual of the identification target cow.

On the other hand, when the minimum value of the integrated determination distances Ljt(ID) is larger than the integrated threshold value Tht, the process proceeds to step S152. The minimum value of the integrated determination distances Ljt(ID) becomes larger than the integrated threshold value Tht when the identification target cow is an unregistered individual, or when there is dirt on the backside of the identification target cow. In this case, the identification determination is executed using a determination value different from the integrated determination distance Ljt(ID).

Note that when the minimum value of the integrated determination distances Ljt(ID) is equal to the integrated threshold value Tht, the process may proceed from step S151 to step S161, or may proceed to step S152. This also applies to other determination steps described later.

In step S152, the individual identification unit 530 determines first type determination distance Lj1(ID) representing N1×N2 first type distances L(1) for each of the n registered individuals. The first type determination distances Lj1(ID) are determined by, for example, any of the following methods.

### Method EM1 of Determining First Type Determination Distance Lj1(ID)

For each of the registered individuals, M1 first type distances L(1) are selected from the smallest values out of the N1×N2 first type distances L(1), and a value proportional to an average value of the M1 first type distances L(1) is determined as the first type determination distance Lj1(ID). Here, M1 is an integer no smaller than 2 and no larger than N1×N2, and is preferably an integer smaller than N1×N2. In addition, it is preferable that the integers N1, N2 are set so that N1×N2 is no smaller than 3.

### Method EM2 of Determining First Type Determination Distance Lj1(ID)

For each of the registered individuals, a value proportional to the minimum value of the N1×N2 first type distances L(1) is determined as the first type determination distance Lj1(ID).

In the second embodiment, the first type determination distance Lj1(ID) is determined using M1=3 and applying the determination method EM1 described above to the p-th type distance shown in FIG. 18. A lower part of FIG. 19 shows the first type determination distances Lj1(ID) determined in this way.

In step S153, the individual identification unit 530 determines whether the minimum value of the first type determination distances Lj1(ID) is smaller than a first threshold value Th1 set in advance. When the minimum value of the first type determination distances Lj1(ID) is smaller than the first threshold value Th1, the process proceeds to step S162, and the registered individual corresponding to the minimum value of the first type determination distances Lj1(ID) is identified as the individual of the identification target cow.

On the other hand, when the minimum value of the first type determination distances Lj1(ID) is larger than the first threshold value Th1, the process proceeds to step S154. In step S154, the individual identification unit 530 determines second type determination distance Lj2(ID) representing N1×N2 second type distances L(2) for each of the n registered individuals. The second type determination distances Lj2(ID) are determined by substantially the same method as the determination methods EM1, EM2 of the first type determination distances Lj1(ID) described above. The lower part of FIG. 19 shows the second type determination distances Lj2(ID) calculated according to substantially the same method as the determination method EM1 described above.

In step S155, the individual identification unit 530 determines whether the minimum value of the second type determination distances Lj2(ID) is smaller than a second threshold value Th2 set in advance. When the minimum value of the second type determination distances Lj2(ID) is smaller than the second threshold value Th2, the process proceeds to step S163, and the registered individual corresponding to the minimum value of the second type determination distances Lj2(ID) is identified as the individual of the identification target cow.

On the other hand, when the minimum value of the second type determination distances Lj2(ID) is larger than the second threshold value Th2, the process proceeds to step S156. In step S156, it is determined that the non-registration condition is satisfied. In this case, step S170 in FIG. 16 is executed.

In step S160a in FIG. 16, it is identified whether the identification target cow is any one of the plurality of registered individuals registered in the registration data 630(p). Note that the processing in steps S161 to S163 in FIG. 20 can be considered to correspond to step S160a in FIG. 16.

According to the processing in FIGS. 16 and 20 described above, the individual of the identification target cow can be determined from the N1×N2p-th type distances related to each of the registered individuals. In particular, in the second embodiment, the individual can be identified using various determination distances including the integrated determination distance Ljt(ID). Further, when the respective minimum values of the three determination distances Ljt(ID), Lj1(ID), and Lj2(ID) are larger than the respective threshold values Tht, Th1, and Th2, it can be determined that the identification target cow is an unregistered individual.

### C. Third Embodiment

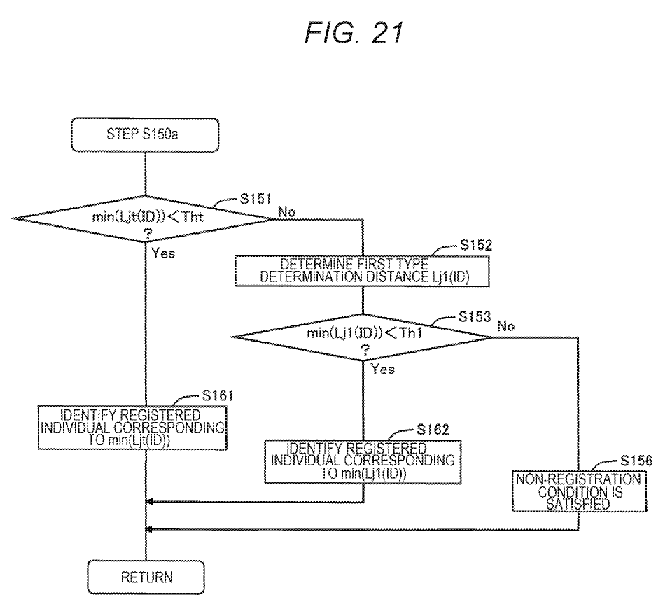

FIG. 21 is a flowchart showing a detailed procedure in step S150a in the third embodiment. The third embodiment is the same as the second embodiment in a configuration of the apparatus and the processing contents in FIGS. 2, 3, and 6. The processing procedure in FIG. 21 is what is obtained by omitting steps S154, S155, and S163 in FIG. 20, and is the same in other steps as that in the second embodiment.

In step S153 in the third embodiment, when the minimum value of the first type determination distances Lj1(ID) is larger than the first threshold value Th1, the process proceeds to step S156, and it is determined that the non-registration condition is satisfied.

The third embodiment has substantially the same advantages as those of the second embodiment. Further, according to the processing in FIG. 21, when the respective minimum values of the integrated determination distances Ljt(ID) and the first type determination distances Lj1(ID) are larger than the respective threshold values, it can be determined that the identification target cow is an unregistered individual.

### D. Fourth Embodiment

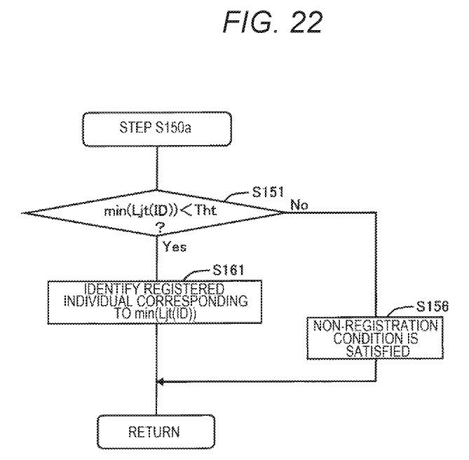

FIG. 22 is a flowchart showing a detailed procedure in step S150a in a fourth embodiment. The fourth embodiment is the same as the second embodiment and the third embodiment in a configuration of the apparatus and the processing contents in FIGS. 2, 3, and 6 . The processing procedure in FIG. 22 is what is obtained by omitting steps S152, S153, and S162 in FIG. 21, and is the same in other steps as that in the third embodiment.

In step S151 in the fourth embodiment, when the minimum value of the integrated determination distances Ljt(ID) is larger than the integrated threshold value Tht, the process proceeds to step S156, and it is determined that the non-registration condition is satisfied.

The fourth embodiment also has substantially the same advantages as those of the second embodiment and the third embodiment. Further, according to the processing in FIG. 22, when the minimum value of the integrated determination distances Ljt(ID) is larger than the threshold value, it can be determined that the identification target cow is an unregistered individual.

Note that the processing in FIG. 20, the processing in FIG. 21, and the processing in FIG. 22 are the same in that it is determined that the identification target cow is an unregistered individual when the non-registration condition including that the minimum value of the integrated determination distances Ljt(ID) is larger than the integrated threshold value Tht is satisfied.

### Other Aspects

The present disclosure is not limited to the embodiments described above, and can be implemented in various forms without departing from the spirit of the present disclosure. For example, the present disclosure can be implemented by the following aspects. The technical features in the embodiments described above corresponding to the technical features in the aspects described below can be replaced or combined as appropriate in order to solve a part or all of the problems of the present disclosure, or to achieve a part or all of the advantages of the present disclosure. Further, any of the technical features can be eliminated as appropriate unless described as essential in the present specification.

(1) According to a first aspect of the present disclosure, a method of performing individual identification of an identification target animal is provided. This method includes: (a) acquiring a target image related to a backside of the identification target animal; (b) obtaining an embedding vector from the target image using a deep metric learning model; (c) calculating a distance between a registered embedding vector generated in advance related to each of a plurality of registered individuals and the embedding vector using registration data including the registered embedding vector; (d) determining whether the identification target animal is any of the plurality of registered individuals or an unregistered individual using the distance; (e) registering data related to the identification target animal as temporary registration data when the identification target animal is the unregistered individual; and (f) making a transition of the temporary registration data to the registration data when the temporary registration data satisfies a transition condition set in advance.

According to this method, the embedding vector can be obtained from the target image related to the backside of the identification target animal by using the deep metric learning model, and the individual can be identified using the distance between the embedding vector and the registered embedding vector. Further, when the identification target animal is an unregistered individual, the temporary registration data can be registered, and when the temporary registration data satisfies the registration condition set in advance, the unregistered individual can be registered as a registered individual.

(2) In the method described above, the step (e) may include registering, in the temporary registration data, the identification target animal as a temporarily registered individual, the embedding vector as temporarily registered embedding vector data, and a number of times of temporary registration of the temporarily registered individual, and the step (f) may include making the transition of data related to the temporarily registered individual registered in the temporary registration data to the registration data when the number of times of temporary registration of the temporarily registered individual is equal to or greater than a threshold value of the number of times.

According to this method, since the transition of the data related to the temporarily registered individual from the temporary registration data to the registration data is made when the number of times of temporary registration is equal to or greater than the threshold value of the number of times, an appropriate registered individual can be registered in the registration data.

(3) The method described above may further include (g) deleting the data related to the temporarily registered individual from the temporary registration data when the temporarily registered individual satisfies a deletion condition set in advance.

According to this method, an unnecessary temporarily registered individual can be deleted.

(4) In the method described above, the step (g) may include deleting the data related to the temporarily registered individual from the temporary registration data when a registration period of the temporarily registered individual exceeds an allowable registration period set in advance before the number of times of temporary registration reaches the threshold value of the number of times.

According to this method, an unnecessary temporarily registered individual can be deleted.

(5) In the method described above, the step (a) may include acquiring N1p-th type target images using a p-th type image sensor with respect to the backside of the identification target animal, where p is an ordinal number from 1 to 2 and N1 is an integer no smaller than 1, the step (b) may include obtaining N1p-th type embedding vectors from the N1p-th type target images using a p-th deep metric learning model, and the step (c) may include calculating N1×N2p-th type distances between the N1p-th type embedding vectors and N2p-th type registered embedding vectors using the N2p-th type registered embedding vectors generated in advance with respect to each of n registered individuals, where n and N2 are integers no smaller than 2. The step (d) may include (d1) obtaining an integrated determination distance obtained by integrating N1×N2 first type distances and N1×N2 second type distances for each of the n registered individuals, (d2) determining that a registered individual corresponding to a minimum value of the integrated determination distance is an individual of the identification target animal when the minimum value of the integrated determination distance is smaller than an integrated threshold value set in advance, and (d3) determining that the identification target animal is the unregistered individual when a non-registration condition including that the minimum value of the integrated determination distance is larger than the integrated threshold value is satisfied.

According to this method, two types of embedding vectors can be obtained from two types of target images related to the backside of the identification target animal using the two deep metric learning models, and the individual can be identified using the integrated determination distance determined from the distances between the two types of embedding vectors and the two types of registered embedding vectors. Further, when the non-registration condition is satisfied, it can be determined that the identification target animal is an unregistered individual.

(6) In the method described above, the integrated determination distance related to each of the n registered individuals may be a value proportional to a value obtained by adding a first type distance average value obtained by averaging M first type distances selected from a smallest value out of the N1×N2 first type distances and a second type distance average value obtained by averaging M second type distances selected from a smallest value out of the N1×N2 second type distances, where M is an integer no smaller than 2 and no larger than N1×N2.

According to this method, an appropriate integrated determination distance can be calculated.

(7) In the method described above, the step (d3) may include (d3-1) determining a first type determination distance representing the N1×N2 first type distances for each of the n registered individuals, and (d3-2) determining that a registered individual corresponding to a minimum value of the first type determination distances is an individual of the identification target animal when the minimum value of the n first type determination distances is smaller than a first type threshold value set in advance.

(8) In the method described above, the step (d3) may further include (d3-3) determining a second type determination distance representing the N1×N2 second type distances for each of the n registered individuals when the minimum value of the first type determination distances is larger than the first type threshold value, (d3-4) determining that a registered individual corresponding to the minimum value of the second type determination distances is an individual of the identification target animal when the minimum value of the n second type determination distances is smaller than a second type threshold value set in advance, and (d3-5) determining that the identification target animal is an unregistered individual that does not correspond to any of the plurality of registered individuals when the minimum value of the second type determination distances is larger than the second type threshold value.

According to this method, it is possible to determine whether the identification target animal is any of the registered individuals or an unregistered individual in accordance with the first type determination distances and the second type determination distances.

(9) In the method described above, the step (d3) may further include (d3-3) determining that the identification target animal is an unregistered individual when the minimum value of the first type determination distances is larger than the first type threshold value.

According to this method, it is possible to determine whether the identification target animal is any of the registered individuals or an unregistered individual in accordance with the first type determination distances.

(10) In the method described above, the first type determination distance for each of the n registered individuals may be a value proportional to a first type distance average value obtained by averaging M first type distances selected from the smallest value out of the N1×N2 first type distances, where M is an integer no smaller than 2 and no larger than N1×N2.

According to this method, an appropriate first type determination distances can be calculated.

(11) According to a second aspect of the present disclosure, there is provided a non-transitory computer-readable storage medium storing a computer program configured to make a processor execute processing of individual identification of an identification target animal. This computer program makes the processor execute the processing including: (a) acquiring a target image related to a backside of the identification target animal; (b) obtaining an embedding vector from the target image by using a deep metric learning model; (c) calculating a distance between a registered embedding vector generated in advance for each of a plurality of registered individuals and the embedding vector by using registration data including the registered embedding vector; (d) determining whether the identification target animal is any of the plurality of registered individuals or an unregistered individual that is not registered in the registration data using the distance; (e) registering data related to the identification target animal as temporary registration data when the identification target animal is the unregistered individual; and (f) making a transition of the temporary registration data to the registration data when the temporary registration data satisfies a transition condition set in advance.

The present disclosure can be implemented in various forms other than the above. For example, the present disclosure can be implemented in the form of an apparatus that realizes the individual identification processing or a non-transitory storage medium storing the computer program.

What is claimed is:

1. A method of individual identification of an identification target animal, the method comprising:
(a) acquiring a target image related to a backside of the identification target animal;
(b) obtaining an embedding vector from the target image using a deep metric learning model;
(c) calculating a distance between a registered embedding vector generated in advance related to each of a plurality of registered individuals and the embedding vector using registration data including the registered embedding vector;
(d) determining whether the identification target animal is any of the plurality of registered individuals or an unregistered individual using the distance;
(e) registering data related to the identification target animal as temporary registration data when the identification target animal is the unregistered individual; and
(f) making a transition of the temporary registration data to the registration data when the temporary registration data satisfies a transition condition set in advance.

2. The method according to claim 1, wherein
the step (e) includes
registering, in the temporary registration data, the identification target animal as a temporarily registered individual, the embedding vector as temporarily registered embedding vector data, and a number of times of temporary registration of the temporarily registered individual, and
the step (f) includes
making the transition of data related to the temporarily registered individual registered in the temporary registration data to the registration data when the number of times of temporary registration of the temporarily registered individual is equal to or greater than a threshold value of the number of times.

3. The method according to claim 2, further comprising
(g) deleting the data related to the temporarily registered individual from the temporary registration data when the temporarily registered individual satisfies a deletion condition set in advance.

4. The method according to claim 3, wherein
the step (g) includes deleting the data related to the temporarily registered individual from the temporary registration data when a registration period of the temporarily registered individual exceeds an allowable registration period set in advance before the number of times of temporary registration reaches the threshold value of the number of times.

5. The method according to claim 1, wherein
the step (a) includes acquiring N1 p-th type target images using a p-th type image sensor with respect to the backside of the identification target animal, where p is an ordinal number from 1 to 2 and N1 is an integer no smaller than 1,
the step (b) includes obtaining N1 p-th type embedding vectors from the N1 p-th type target images using a p-th deep metric learning model,
the step (c) includes calculating N1×N2 p-th type distances between the N1 p-th type embedding vectors and N2 p-th type registered embedding vectors using the N2 p-th type registered embedding vectors generated in advance with respect to each of n registered individuals, where n and N2 are integers no smaller than 2, and
the step (d) includes
(d1) obtaining an integrated determination distance obtained by integrating N1×N2 first type distances and N1×N2 second type distances for each of the n registered individuals,
(d2) determining that a registered individual corresponding to a minimum value of the integrated determination distance is an individual of the identification target animal when the minimum value of the integrated determination distance is smaller than an integrated threshold value set in advance, and
(d3) determining that the identification target animal is the unregistered individual when a non-registration condition including that the minimum value of the integrated determination distance is larger than the integrated threshold value is satisfied.

6. The method according to claim 5, wherein
the integrated determination distance related to each of the n registered individuals is a value proportional to a value obtained by adding a first type distance average value obtained by averaging M first type distances selected from a smallest value out of the N1×N2 first type distances and a second type distance average value obtained by averaging M second type distances selected from a smallest value out of the N1×N2 second type distances, where M is an integer no smaller than 2 and no larger than N1×N2.

7. The method according to claim 5, wherein
the step (d3) includes
(d3-1) determining a first type determination distance representing the N1×N2 first type distances for each of the n registered individuals, and
(d3-2) determining that a registered individual corresponding to a minimum value of the first type determination distances is an individual of the identification target animal when the minimum value of the n first type determination distances is smaller than a first type threshold value set in advance.

8. The method according to claim 7, wherein
the step (d3) further includes
(d3-3) determining a second type determination distance representing the N1×N2 second type distances for each of the n registered individuals when the minimum value of the first type determination distances is larger than the first type threshold value,
(d3-4) determining that a registered individual corresponding to the minimum value of the second type determination distances is an individual of the identification target animal when the minimum value of the n second type determination distances is smaller than a second type threshold value set in advance, and
(d3-5) determining that the identification target animal is an unregistered individual that does not correspond to any of the plurality of registered individuals when the minimum value of the second type determination distances is larger than the second type threshold value.

9. The method according to claim 7, wherein
the step (d3) further includes
(d3-3) determining that the identification target animal is an unregistered individual when the minimum value of the first type determination distances is larger than the first type threshold value.

10. The method according to claim 7, wherein
the first type determination distance for each of the n registered individuals is a value proportional to a minimum value of the N1×N2 first type distances.

11. A non-transitory computer-readable storage medium storing a computer program configured to make a processor execute processing of individual identification of an identification target animal, the processing comprising:
(a) acquiring a target image related to a backside of the identification target animal;
(b) obtaining an embedding vector from the target image by using a deep metric learning model;
(c) calculating a distance between a registered embedding vector generated in advance for each of a plurality of registered individuals and the embedding vector by using registration data including the registered embedding vector;
(d) determining whether the identification target animal is any of the plurality of registered individuals or an unregistered individual that is not registered in the registration data using the distance;
(e) registering data related to the identification target animal as temporary registration data when the identification target animal is the unregistered individual; and
(f) making a transition of the temporary registration data to the registration data when the temporary registration data satisfies a transition condition set in advance.
